(19) United States
(12) Patent Application Publication
(10) Pub. No.: US 2006/0127771 A1
(43) Pub. Date: Jun. 15, 2006

(54) Energy storage device

(76) Inventors: Takahiro Yamaki, Hitachinaka (JP); Juichi Arai, Shirosato (JP); Yoshiaki Kumashiro, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/206,184

(22) Filed: Aug. 18, 2005

(30) Foreign Application Priority Data
Dec. 14, 2004 (JP) 2004-360672

(51) Int. Cl. H01M 4/58; H01G 9/042

(52) U.S. Cl. 429/231.8; 361/508

(57) ABSTRACT

An energy storage device of excellent input/output characteristics and having high density of stored energy, the device having a cathode comprising a material conducting faradic reaction and a material conducting non-faradic reaction, and an anode comprising a material conducting faradic reaction, in which the faradic reaction is desorption/intercalation reaction of lithium ions, higher input/output characteristics being obtainable by providing a mix layer comprising a material conducting faradic reaction on a cathode collector and providing a material layer conducting non-faradic reaction further to the surface layer thereof.

### FIELD OF THE INVENTION

The present invention concerns an energy storage device for storing and releasing electric energy.

### BACKGROUND OF THE INVENTION

In recent years, a power source of higher input and output than usual has been demanded as a power source for electric vehicles, hybrid electric vehicles or electromotive tools, and a power source being capable of charging and discharging more rapidly and increased with capacity has been demanded.

Particularly, a power source with less dependence on temperature and capable of maintaining input/output characteristics even at a low temperature of −20° C. to −30° C.

The demand described above has been coped with by improving the performance of a secondary battery such as a lithium secondary battery, nickel hydrogen battery, nickel cadmium battery or lead battery mainly having faradic reaction mechanism in combination with the use of an electric double layer capacitor having favorable input/output characteristics and characteristics under low temperature circumstance as a power source having non-faradic reaction mechanism and capable of instantaneous input and output.

Further, a lithium secondary battery has been proposed in which active carbon used as a material for the electric double layered capacitor is mixed in the cathode of a lithium secondary battery with an aim of improving the high energy density, high output density and low temperature characteristics in JP-A No. 2002-260634.

### SUMMARY OF THE INVENTION

However, the existent lithium secondary battery involves a problem that the charge/discharge characteristics are poor at a large current to deteriorate input/output characteristics. Further, the electric double layer capacitor has a problem that the energy density is low.

The present invention intends to provide an energy storage device excellent in input/output characteristics and having a high storage energy density.

The energy storage device according to the invention has a cathode comprising a material conducting faradic reaction and a material conducting non-faradic reaction, and an anode comprising a material conducting faradic reaction in which the material for the anode comprises at least graphite and non-graphitic carbon.

Particularly, it is preferred that the material conducting faradic reaction and the material conducting the non-faradic reaction are formed in a layered manner.

The present invention can provide an energy storage device excellent in the input/output characteristics and having a high storage energy density.

### BRIEF DESCRIPTION OF THE DRAWINGS

FIG. 1 is a schematic view showing an example of a coin shaped energy storage device;

FIG. 2 shows the ratios of the output and energy amount against the amorphous carbon ratio in an anode mix of energy storage devices according to Example 1 and Comparative Example 1;

FIG. 3 shows the ratios of the output and energy amount against the amorphous carbon ratio in an anode mix energy storage devices according to Example 2 and Comparative Example 2; and

FIG. 4 shows the ratios of the output and energy amount against the amorphous carbon ratio in an anode mix of energy storage devices according to Example 3 and Comparative Example 3;

### DETAILED DESCRIPTION OF THE PREFERRED EMBODIMENTS

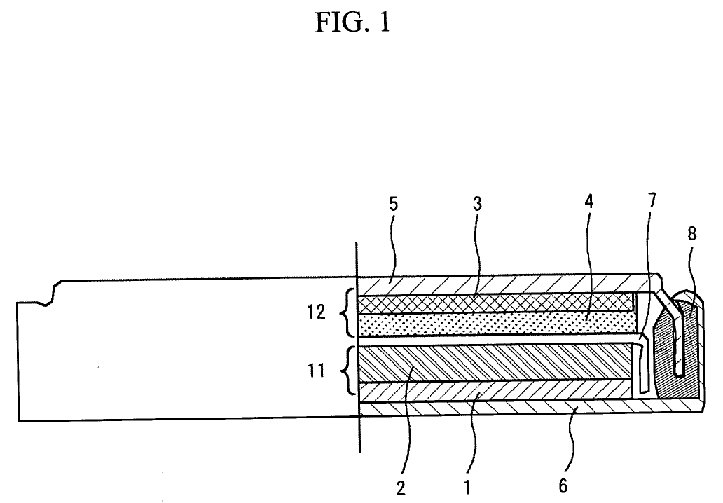

A first embodiment of the invention is to be described below with reference to FIG. 1.

FIG. 1 is a schematic view showing a cross section of a coin shaped energy storage device in an embodiment of the invention.

A cathode 11 comprises a cathode mix layer 2 formed on a cathode collector 1 in which the cathode mix layer 2 comprises a cathode material conducting faradic reaction and a material conducting non-faradic reaction of higher reaction rate than that of the faradic reaction.

An anode 12 comprises an anode mix layer 4 formed on an anode collector 3 in which the anode mix layer 4 has at least two types of materials mainly conducting faradic reaction.

In the faradic reaction of the invention, desorption/intercalation of lithium ions occur to the material conducting the faradic reaction accompanied by formation of compounds, intercalation and formation of inter-metal compounds.

“Faradic reaction” means a reaction in which the oxidized state of an active material changes, charges pass through an electric double layer and transfer through an electrode surface to the inside of the active material. This is a mechanism similar to that of reactions in a primary battery or a secondary battery.

On the other hand, “non-faradic reaction” means a reaction in which charge transfer through the electrode surface does not take place but charges are accumulated and released when ions are physically adsorbed and intercalated to and from the electrode surface. This is a mechanism similar to that of the reaction in an electric double layer capacitor.

Further, there is a reaction accompanied by the faradic reaction in which transfer of electrons to and from to the active material occurs simultaneously with accumulation of charges on the electrode surface, such as the non-faradic reaction. This is a mechanism similar to that of the reaction in an energy storage device referred to as a redox capacitor. While this is accompanied by the faradic reaction, the reaction rate is higher than that of the faradic reaction, for example, in a secondary battery.

In view of the above, the faradic reactions in the redox capacitor and the secondary battery respectively are to be referred to as the faradic reaction of different reaction rate, the reaction in the redox capacitor is referred to as a faradic reaction of high reaction rate, and the reaction in the secondary battery is referred to as a faradic reaction of low reaction rate.

The terms for “faradic” and “non-faradic” are typified by using the terms of “faradic” and “non-faradic” for the type of battery and the type of energy storage.

The feature of the embodiment of the invention is to have at least two types of materials mainly conducting faradic reaction in the anode.

Referring more specifically, it has two or more types of materials which are different in the accumulation energy by the faradic reaction, that is, the desorption/intercalation amount of lithium ions and different in the potential change behavior of the material relative to the desorption/intercalation amount of lithium ions due to the faradic reaction, or different in the non-faradic energy accumulation amount.

Specifically, it includes graphite capable of increasing accumulation energy by the faradic reaction and amorphous carbon changing the potential continuously in accordance with the desorption/intercalation lithium ions.

The stored energy density of an energy storage device can be increased by the action of graphite and, simultaneously, non-faradic reaction can proceed during charge/discharge under a large current by the action of amorphous carbon.

This can provide an energy storage device excellent in input/output characteristics and having high storage energy density.

The function described above can develop more excellent effect by having a material mainly conducting non-faradic reaction for the anode.

The material for mainly conducting faradic reaction and the material for mainly conducting the non-faradic reaction in the anode may be mixed in the anode mix, or the material for mainly conducting the faradic reaction and the material for mainly conducting the non-faradic reaction may be constituted respectively into separate regions. For example, a mix layer formed by mixing graphite and amorphous carbon for mainly conducting the faradic reaction is constituted on an anode collector, and a material layer mainly conducting the non-faradic reaction may be disposed further on the surface layer thereof.

Further, in this embodiment, the cathode material for conducting the faradic reaction in the cathode and the material for conducting the non-faradic reaction in the cathode may be used in admixture with the cathode mix. In a more preferred embodiment, the material conducting the faradic reaction and the material conducting the non-faradic reaction may be constituted respectively in separate regions. For example, in a preferred embodiment, a mix layer comprising a material conducting the faradic reaction is constituted on a cathode collector and a material layer for conducting non-faradic reaction is disposed further on the surface layer thereof.

Since this can concentrate the layer causing the non-faradic reaction at high reaction rate to the side nearer to the opposing anode, an effect similar to that of a capacitor can be developed more and an energy storage device more excellent in the input/output characteristics can be attained.

The energy storage device of this embodiment comprises, as shown in FIG. 1, a cathode 11 comprising a material for conducting the faradic reaction and a material for conducting the non-faradic reaction, and an anode 12 having at least two types of materials mainly conducting the faradic reaction, and the device is manufactured by electrically insulating the cathode 11 and the anode 12, forming an insulative layer 7 for allowing only movable ions to pass therethrough between the cathode 11 and the anode 12, inserting them into a case 6 and then injecting an electrolyte. When the electrolyte is carried sufficiently on the insulative layer 7 and the electrodes (11, 12), electric insulation between the cathode 11 and the anode 12 is ensured and ions can be transferred between the cathode 11 and the anode 12.

An energy storage device of a shape other than the coined shaped can also be manufactured.

In a case of a cylindrical shape, a bundle of electrodes is prepared by opposing the cathode and the anode to each other and winding them while inserting an insulative layer there between.

When the electrodes are wound around two axes, a bundle of electrode of an oval shape can also be obtained.

In a case of a square shape, the cathode and the anode are cut each into a rectangular shape, stacking the cathode and the anode alternately, inserting the insulative layer into between each of the electrodes thereby preparing a bundle of electrodes.

The invention is not restricted to the structure of the bundle of grooves described in this embodiment, that is, coin shape, wound type or square shape, and is applicable to any structure.

The cathode material conducting the faradic reaction is preferably a lithium-containing oxide.

The material usable herein includes, for example, oxides having a layered structure such as LiCoO₂, LiNiO₂, LiMn_{1/3}Nix_{1/3}Co_{1/3}O₂, and LiMn_{0.4}Ni_{0.4}Co_{0.2}O₂, Mn oxides having spinel type crystal structure such as LiMn₂O₄ and Li₁₊ₓMn₂₋ₓO₄, or those substituting a portion of Mn with other element such as Co or Cr.

As the material for conducting the non-faradic reaction, those materials of large specific surface area and not causing oxidation/reduction reaction in a wide potential range, for example, carbon material such as activated carbon, carbon black and carbon nano tube can be used.

For example, use of activated carbon is preferred from the view point of the specific surface area and the material cost. It is more preferred to use activated carbon with a grain size of 1 to 100 μm, a specific surface area of 1000 to 3000 m²/g, and having a pore with a diameter of 0.002 μm or less referred to as a micro-pore and a pore with a diameter of 0.002 to 0.05 μm referred to as a meso pore, and a pore with a diameter of 0.05 μm or more referred to as a macro-pore.

Further, as a material for conducting the non-faradic reaction, a material, for example, electroconductive high polymer material such as polyaniline, polythiophene, polypyrrol, polyacene, or polyacetylene, or fine powder of graphite can also be used.

A cathode is manufactured by coating a cathode slurry formed by mixing a cathode material, optionally, a conductive agent, a binder, a material for conducting non-faradic reaction and a solvent, for example, by a doctor blade method, on a cathode collector, drying the solvent by heating and press forming the cathode, for example, by roll pressing.

The conductive agent is used for compensation of electroconductivity of the cathode material generally at high resistance. As the conductive agent, natural graphite, artificial graphite, coke, carbon black, and amorphous carbon can be used.

Any of materials less soluble to electrolyte may be used as the cathode collector and, for example, an aluminum foil can be used.

The binder is used for fixing the cathode material, the conductive agent and the material for conducting the non-faradic reaction on a collector and it includes a fluorine-containing resin such as polytetrafluoro ethylene, polyvinylidene fluoride, and fluoro rubber, thermoplastic resin such as polypropylene and polyethylene, thermosetting resin such as polyvinyl alcohol, rubber resin such as styrene-butadiene rubber, and celluloses such as methyl ethyl cellulose.

The solvent is selected preferably depending on the kind of the binder and, for example, organic solvent such as N-methyl-pyrrolidone (NMP) or water can be used.

As a more preferred embodiment of the cathode a method of constituting a mix layer comprising a material conducting the faradic reaction on a cathode collector and disposing further on the surface thereof a material layer for conducting non-faradic reaction may be adopted. For the method, it may be considered of coating a cathode slurry formed by mixing a cathode material, a conductive agent, a binder and a solvent excepting for the material conducting the non-faradic reaction, on a cathode collector, drying the solvent, optionally press forming the same and then further coating a cathode slurry formed by mixing a material conducting non-faradic reaction, a binder, solvent and, optionally, a conductive agent, and then drying and press forming the same.

The anode material for mainly conducting the faradic reaction in the anode is a material capable of electrochemically occluding and releasing lithium ions and, in addition to carbon material such as graphite or amorphous carbon, oxide anode such as SnO₂, an alloy material such as Li, Si, or Sn, as well as two or more of composite materials of them are used. Use of two kinds of them, that is, graphite and amorphous carbon is preferred.

The anode is manufactured by coating an anode slurry formed by mixing the two or more anode materials, optionally, a conductive agent, a binder and a solvent, on an anode assembly in the same manner as in the manufacture of the cathode, drying the solvent by heating and press forming the anode, for example, by roll pressing.

As the anode collector, a material less alloying with lithium, for example, a copper foil can be used.

Further, the anode can be manufactured in the same manner as in the cathode by mixing a material conducting the non-faradic reaction, for example, a carbon material such as active carbon, carbon black, or carbon nano tube, with the anode slurry, coating, drying and then press forming the mixture. Further, the anode can be manufactured, like the cathode, by coating an anode slurry formed by mixing two or more anode materials, optionally, a conductive agent, a binder, and a solvent, and by coating a slurry formed by mixing an anode material anode active material, a binder and an organic solvent, on an anode collector, drying and, optionally, press forming the same, and then further coating a slurry formed by mixing a material conducting non-faradic reaction, a binder, a solvent and, optionally, a conducting agent on the anode collector and then drying and press forming the same.

The insulative layer 7 electrically insulates the cathode 11 and the anode 12 and is constituted, for example, by polymeric porous film such as polyethylene, polypropylene, tetrafluoro ethylene for allowing only movable ions to pass therethrough.

As the electrolyte, an organic solvent such as ethylene carbonate (EC), propylene carbonate (PC), dimethyl carbonate (DMC), diethyl carbonate (DEC), or methyl ethyl carbonate (MEC) incorporated with lithium hexafluoro phosphate (LiPF₆), lithium tetra fluoro borate (LiBF₄) by 0.5 to 2M volumic concentration can be used.

In FIG. 1, reference 5 denotes a lid, 6 denotes a casing, and 8 denotes a packing, respectively.

Further detailed examples of the energy storage device according to the embodiment are shown below and described specifically. However, the embodiment is not restricted to the examples to be described later.

The examples to be described later concerns an energy storage device having a cathode comprising a cathode material conducting the faradic reaction and a material conducting the non-faradic reaction and an anode, in which the faradic reaction is the desorption/intercalation reaction of lithium ions, and the anode comprises two or more kinds of materials mainly conducting the faradic reaction.

The application use of the energy storage device described for this embodiment has no-particular restriction. The device is applicable, for example, as a power supply for personal computer, word processor, codeless telephone subunit, electronic book player, mobile telephone, vehicle telephone, pocket beeper, handy terminal, transceiver, portable wireless equipments and like other portable information communication units, or as a power supply for portable copier, electronic note book, electronic desk top calculator, liquid crystal television set, radio receiver, tape recorder, headphone stereo-equipment, portable CD player, video movie, electric shaver, electronic translation machine, voice input equipment, memory card, and like other various portable equipments, as well as for home electric apparatus such as refrigerator, air conditioner, television set, stereophonic unit, water warmer, electronic oven, tableware washing machine, dryer, laundry machine, illumination instruments, and toys and, further, for industrial application use such as medical equipments, power storage system, elevator, etc.

This embodiment has practically high effect in equipments or systems requiring high input/output power and it is effectively used as a power supply for mobile bodies such as electric vehicles, hybrid electric vehicles and golf carts.

### EXAMPLES

### Example 1

A coin shaped energy storage device was manufactured with a constitution shown in FIG. 1.

At first, a cathode comprising a material layer conducting the non-faradic reaction was manufactured on a cathode faradic layer.

The cathode material was made of LiMn_{0.35}Nix_{0.35}Co_{0.30}O₂ of 10 μm in average particle diameter.

As the conductive aid, graphitic carbon with an average grain size of 3 μm and a specific surface area of 13 m²/g, and carbon black with an average grain size of 0.04 μm and a specific surface area of 40 m²/g mixed at 4:1 weight ratio was used.

As the binder, a solution in which polyvinylidene fluoride was previously dissolved by 8 wt % in N-methyl pyrrolidone was used.

Then, the cathode active material, the conductive aid and the polyvinylidene fluoride mixed at a weight ratio of 85:10:5 and kneaded sufficiently was used as the cathode slurry. The cathode slurry was coated and dried on one surface of a cathode collector comprising an aluminum foil of 20 μm thickness. The coated slurry was pressed by a roll pressing to manufacture a cathode material layer on a collector.

Further, activated carbon with a specific surface area of 2000 m²/g, and carbon black with an average grain size of 0.04 μm and a specific surface area of 40 m²/g were mixed at a weight ratio of 8:1, a solution formed by dissolving 8 wt % of polyvinylidene fluorite previously into N-methyl pyrrolidone was used as the binder, and activated carbon, carbon black and polyvinylidene fluorite were mixed at a weight ratio of 80:10:10 and kneaded sufficiently to prepare a slurry.

The slurry was coated and dried on the cathode material layer, dried and then pressed by a roll pressing to prepare an electrode. The electrode was punched out into a disk-like shape of 16 mm diameter to form an anode 11.

The total weight of the cathode mix was conditioned to 15 mg/cm². The weight ratio of the cathode active material, the conductive aid, the polyvinylidene fluorite (active carbon:cathode active material: 19 wt %) and the active carbon to the total weight of the cathode mix was 68:10:6:16 by weight ratio and the weight of the activated carbon was 16 wt %.

Then, an anode was manufactured.

For the anode material, amorphous carbon with an average grain size of 10 μm, and spherical natural graphite coated with a carbon layer by a chemical vapor deposition method with an average grain size of 16 μm were selected. Carbon black with an average grain size of 0.04 μm and a specific surface area of 40 m²/g was mechanically mixed at a weight ratio of 95:5 to the anode mix material formed by mixing the amorphous carbon graphite with the spherical natural graphite. The mixing ratio between the amorphous carbon and graphite in the anode mix was set to 95:5, 80:20, 50:50, 20:80, and 5:95.

As the binder, a solution of 8 wt % polyvinylidene fluoride previously dissolved in N-methyl pyrrolidone was used. And it was kneaded sufficiently with the carbon material comprising previously mixed amorphous carbon and carbon black such that the weight ratio of the carbon material to the polyvinylidene fluoride was 90:10. The slurry was coated on one surface of an anode collector 3 comprising a copper foil of 10 μm thickness and dried. It was pressed by a roll pressing to manufacture an electrode. The weight of the anode mix was controlled to 4.5 mg/cm². The electrode was punched out into a disk-like shape with 16 mm diameter to form an anode 12.

An insulative layer 7 comprising a porous polyethylene separator of 40 μm thickness was put between the cathode and anode which was housed in a casing into which a mixed electrolyte comprising 1.5 mol/dm³ LiPF₆ of ethylene carbonate and ethyl methyl carbonate (volume ratio: 1/9) was injected. Then, a cap 5 was put on and sealed by way of a gasket.

### Comparative Example 1

As an energy storage device of Comparative Example 1, an energy storage device having the anode material comprising only the amorphous carbon in Example 1, and an energy storage device having the anode material only comprising graphite were manufactured in the same manner as in Example 1.

Evaluation Method for Output Characteristics and Energy Amount

The energy storage devices of Example 1 and Comparative Example 1 were charged and discharged under the following conditions at a temperature of 25° C. At first, charging at a constant current with a current density of 0.85 mA/cm² up to a voltage of 4.1 V and then a constant current/constant voltage charging of charging at a constant voltage of 4.1 V was conducted for three hours. After completing the charging, with a rest time of 30 min, they were discharged at a constant current with a current density of 0.28 mA/cm² up to the discharge termination voltage of 2.7 V. The test cycle was repeated for 5 cycles and the discharge capacity at 5th cycle was defined as an energy amount of each energy storage device.

Then, after conducting constant current/constant voltage charging for three hours by first charging at a constant current with a current density of 0.85 mA/cm² up to a voltage of 4.1 V and secondly charging at a constant voltage of 4.1 V, discharging was conducted at 0.28 mA/cm² up to the amount corresponding to 50% of the energy amount measured as described above, and the charged state was defined as DOD=50%. Then after lapse of about one hour, discharging for a short period of time of 10 sec was conducted at a current with a current density of 1.7 mA/cm², 5.5 mA/cm², and 11 mA/cm², and the output characteristic was examined.

With 10 min rest after each discharge, the capacity discharged by each discharging was charged with a current density of 0.17 mA/cm². For example, charging after discharge with a current density of 1.7 mA/cm² for 10 sec was conducted with a current density of 0.17 mA/cm² for 100 sec. With 30 min rest after the charging, the next measurement was conducted after stabilization of the voltage. From the charge/discharge curve obtained by the charge/discharge test for 10 sec, a voltage at 2 sec after start of the discharge was read, which was plotted with the current value during measurement being on the abscissa and with the voltage value 2 sec after start of the measurement being on the ordinate, which was extrapolated with a straight line determined by the least square method in view of I-V characteristics to determine a current value P crossing at 2.5 V. The output was calculated as: (current value Imax at the extrapolated intersection P)×(starting voltage Vo for each charge/discharge).

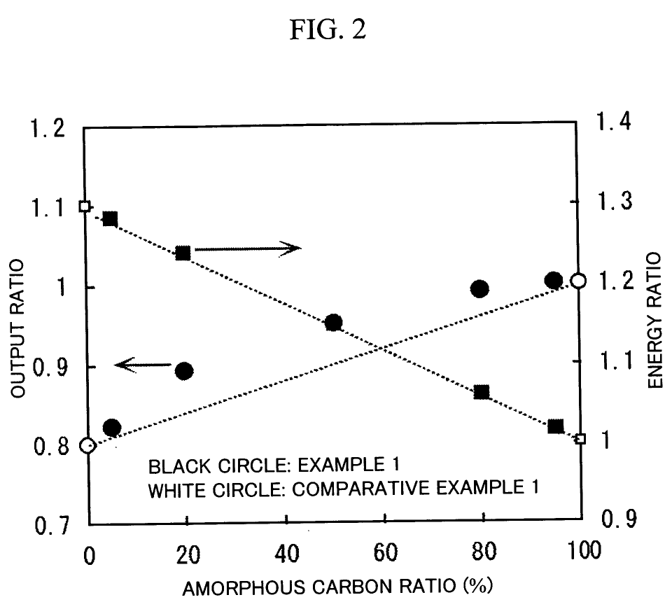

FIG. 2 shows the result of the output and the energy amount against the amorphous carbon ratio in the anode mix of the energy storage device of Example 1 and Comparative Example 1. The output and the energy amount are shown by a ratio based on that value of the energy storage device of Comparative Example 1 manufactured by using only the amorphous carbon is assumed as 1.

As shown in FIG. 2, the energy amount of the energy storage device constituted with the anode formed by mixing graphite and amorphous carbon in Example 1 shows an identical value for the energy amount predicted or expected from the additive rule for the output of the energy storage device constituted with the anode only consisting of graphite and the anode only consisting of amorphous carbon in Comparative Example 1.

On the other hand, the output of the energy storage device constituted with the anode formed by mixing graphite and amorphous carbon in Example 1 shows a higher value than the output predicted by the additive rule for the output of the energy storage device constituted with the anode only constituting of graphite and the anode only consisting of amorphous carbon in Comparative Example 1.

Accordingly, with the constitution of the anode formed by mixing graphite and amorphous carbon, it showed an effect capable of obtaining high energy density and high input/output characteristics.

### Example 2

As the energy storage device of Example 2, a carbon black layer with a specific surface area of 40 m²/g like the cathode was disposed on the anode and the energy storage device was manufactured in the same manner as in Example 1 than described above. The mixing ratio between amorphous carbon and graphite in the anode mix in Example 2 was set to 80:20, 50:50, and 20:80.

### Comparative Example 2

As an energy storage device of Comparative Example 2, an energy storage device having the anode material consisting only of the amorphous carbon in Example 2 and an energy storage device having the anode material consisting only of the graphite were manufactured in the same manner as in Example 2.

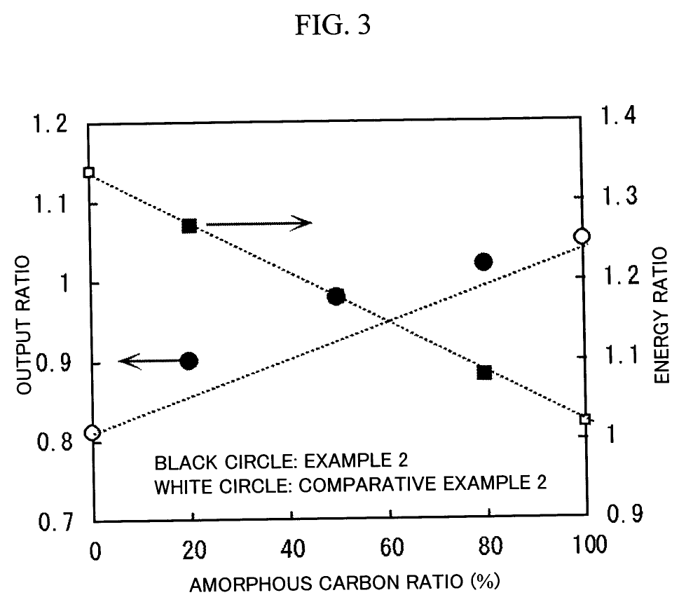

FIG. 3 shows the result of the output and the energy amount against the amorphous carbon ratio in the anode mix of the energy storage device of Example 2 and Comparative Example 2. The output and the energy amount are shown by a ratio based on that value of the energy storage device of Comparative Example 2 manufactured by using only the amorphous carbon is assumed as 1.

As shown in FIG. 3, the energy amount of the energy storage device constituted with the anode formed by mixing graphite and amorphous carbon in Example 2 shows an identical value for the energy amount predicted from the additive rule for the output of the energy storage device constituted with the anode only consisting of graphite and the anode only consisting of amorphous carbon in Comparative Example 2.

On the other hand, the output of the energy storage device constituted with the anode formed by mixing graphite and amorphous carbon in Example 2 shows a higher value than the output predicted by the additive rule for the output of the energy storage device constituted with the anode only constituting of graphite and the anode only consisting of amorphous carbon in Comparative Example 2.

Accordingly, with the constitution of the anode formed by mixing the graphite and amorphous carbon, it showed an effect capable of obtaining high energy density and high input/output characteristics.

Further, when the output of the energy storage devices with the amorphous carbon ratio of 50% in Example 1 and Example 2 were compared, the output of the energy storage device of Example 2 was superior.

Accordingly, provision of the material mainly conducting the non-faradic reaction to the anode provided an effect capable of obtaining higher input/output characteristics.

### Example 3

In Example 3, the cathode of Example 1 was changed to a cathode comprising a mix formed by mixing the material conducting the faradic reaction and the material conducting the non-faradic reaction which was used as a cathode and the energy storage device like in Example 1 was manufactured.

A cathode mix layer was prepared such that the same cathode material, the conductive aid, the polyvinylidene fluoride (activated carbon/cathode active material: 19 wt %) and active carbon as in Example 1 were at the weight ratio of 68:10:6:16. The energy storage device was manufactured in the same manner as in Example 1 only except for the charge of the ratio. The mixing ratio between the amorphous carbon and graphite in the anode mix in Example 3 was controlled to 80:20, 50:50, and 20:80.

### Comparative Example 3

As an energy storage device of Comparative Example 3, an energy storage device having the anode material only consisting of the amorphous carbon in Example 3 and an energy storage device having the anode material only consisting of graphite were manufactured in the same manner as in Example 3.

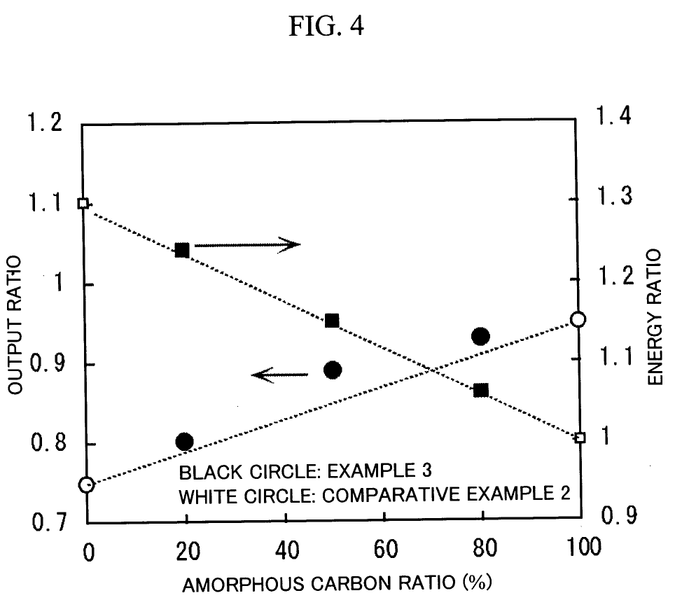

FIG. 4 shows the result of the output and the energy amount against the amorphous carbon ratio in the anode mix of the energy storage device of Example 3 and Comparative Example 3. The output and the energy amount are shown by a ratio based on that value of the energy storage device of Comparative Example 1 manufactured by using only the amorphous carbon is assumed as 1.

As shown in FIG. 4, the energy amount of the energy storage device constituted with the anode formed by mixing graphite and amorphous carbon in Example 3 shows an identical value for the energy amount predicted from the additive rule for the output of the energy storage device constituted with the anode only consisting of graphite and the anode only consisting of amorphous carbon in Comparative Example 3.

On the other hand, the output of the energy storage device constituted with the anode formed by mixing graphite and amorphous carbon in Example 3 shows a higher value than the output predicted by the additive rule for the output of the energy storage device constituted with the anode only constituting of graphite and the anode only consisting of amorphous carbon in Comparative Example 3.

Accordingly, with the constitution of the anode formed by mixing the graphite and amorphous carbon, it showed an effect capable of obtaining high energy density and high input/output characteristics.

Further, when the output of the energy storage devices with the amorphous carbon ratio of 50% in Example 1 and Example 3 were compared, the output of the energy storage device of Example 1 was superior.

Accordingly, constitution of the mix layer comprising the material conducting the faradic reaction on the cathode collector and provision of the material layer mainly conducting the non-faradic reaction further to the surface layer thereof provided an effect capable of obtaining higher input/output characteristics.

The present invention concerns an energy storage device.

What is claimed is:

1. An energy storage device having a cathode comprising a material conducting faradic reaction and a material conducting non-faradic reaction, and
an anode comprising a material conducting faradic reaction, in which
the material for the anode has at least graphite and non-graphitic carbon

2. An energy storage device according to claim 1, wherein the material conducting faradic reaction and the material conducting non-faradic reaction of the cathode are formed in a layered state.

3. An energy storage device according to claim 1, wherein the faradic reaction in the cathode is desorption/intercalation reaction of lithium ions.

4. An energy storage device according to claim 1, wherein the faradic reaction in the anode is desorption/intercalation reaction of lithium ions.

5. An energy storage device according to claim 1, wherein the anode has a material conducting non-faradic reaction together with the material for conducting faradic reaction.

6. An energy storage device having a cathode formed with a region having a faradic reaction mechanism and a region having a non-faradic reaction mechanism, and an anode having a material conducting faradic reaction, in which two kinds of the material of the anode conducting the faradic reaction are contained.

7. An energy storage device according to claim 6, wherein the material conducting faradic reaction and the material conducting non-faradic reaction of the cathode are formed in a layered state.

8. An energy storage device according to claim 7, wherein the faradic reaction in the cathode is desorption/intercalation reaction of lithium ions.

9. An energy storage device according to claim 7, wherein the faradic reaction in the anode is desorption/intercalation reaction of lithium ions.

10. An energy storage device according to claim 7, wherein the anode has a material conducting non-faradic reaction together with the material for conducting faradic reaction.

11. An energy storage device according to claim 6, wherein the material conducting faradic reaction of the anode comprises graphite and non-graphitic carbon.
